(19) United States
(12) Patent Application Publication
(10) Pub. No.: US 2026/0171879 A1
(43) Pub. Date: Jun. 18, 2026

(54) METHOD, DEVICE AND USE FOR SEPARATING, ALIGNING AND INSERTING SLOT COVER SLIDES FOR A STATOR

(71) Applicant: GROB-WERKE GmbH & Co. KG, MINDELHEIM (DE)

(72) Inventors: Manfred ZIEGLER, HILTENFINGEN (DE); Markus SCHMÖLZ, RIEDEN (DE)

(21) Appl. No.: 18/708,040

(22) PCT Filed: May 19, 2023
(86) PCT No.: PCT/EP2023/063491

§ 371 Date: May 7, 2024

(30) Foreign Application Priority Data
May 27, 2022 (DE) 102022001866.7
Dec. 5, 2022 (EP) 22211508.1

(51) Int. Cl. H02K 15/13

(52) U.S. Cl. CPC H02K 15/13

(57) ABSTRACT

A separating method and device for separating slot cover slides for covering stator slots provided with conductors for forming a coil winding in the manufacture of a stator. Strip-shaped slot cover slides are provided aligned with each other in the longitudinal direction, but are otherwise disordered. A counterpart is provided which has an upwardly facing surface with an upwardly open slot complementarily adapted to the shape of a slot cover slide. The slot cover slides are arranged parallel to the slot. The slot cover slides are moved relative to the counterpart in a direction transverse to the longitudinal extension of the slot and the slot cover slides aligned therewith. A slot cover slide is inserted into the slot aligned the slot cover slide respect to its rotational position about its longitudinal axis in the slot.

### CROSS-REFERENCES TO RELATED APPLICATIONS

This application is a national phase of International Patent Application No. PCT/EP2023/063491, filed on May 19, 2023, which claims the benefit of German Patent Application No. 10 2022 001 866.7, filed on May 27, 2022, and the benefit of European Patent Application No. 22 211 508.1, filed on Dec. 5, 2022, the entire disclosures of which are incorporated herein by way of reference.

### FIELD OF THE INVENTION

The invention relates to a separating method to be carried out in the course of manufacturing a stator for separating slot cover slides for covering stator slots provided with conductors for forming a coil winding. The invention also relates to a method to be carried out in the course of a manufacturing process for a stator for inserting slot cover slides into stator slots for the purpose of covering conductors located therein using such a separating method. The invention also relates to a separating device for carrying out the separating process and to the use of such a separating device in the manufacture of stators.

### BACKGROUND OF THE INVENTION

For the technological background to slot cover slides and manufacturing methods for manufacturing stators using slot cover slides, reference is made to the following literature:
[1] DE102017101381A1
[2] DE102017002420A1
[3] DE102016111478B4
[4] DE102016124534B4
[5] DE102016113894A1
[6] DE102016111482B4
[7] DE102017119838A1

Stators of electrical machines usually have a stator component formed from a laminated core with stator slots in which conductors of coils are accommodated. In some stators, the individual stator slots provided with conductors are each covered with a slot cover slide that is inserted into the stator slots. The slot cover slides are strip-shaped so that they extend with their largest dimension in a longitudinal direction. The outer contour and the cross-section of the slot cover slides are designed corresponding to the insertion at the stator slot. For example, the slot cover slides have side surfaces extending in the longitudinal direction, one of which faces the inside of the stator slot in the intended use and the other of which faces the rotor of the electric machine.

Slot cover slides are difficult to handle due to their design, as they have a rod-shaped, narrow geometry, often with rounded corners. In addition, they are usually supplied as a bulk material without orientation. Very precise orientation is required to insert the cover slides.

In current practical processes used in various manufacturing companies, the slot cover slides are laboriously separated by hand from a bulk material supply (such as KLT (small load) containers or similar) and inserted into magazines in the correct position. This process, in which the worker removes the cover slides individually from a box, for example, and places them in magazines, is extremely time-consuming and requires a large number of workers (depending on the cycle time). The slot cover slides can then be further processed automatically by positioning the magazines in front of the stator's laminated stack and inserting the cover slides.

The invention is based on the problem of significantly improving the handling of slot cover slides during the production of stators.

### SUMMARY OF THE INVENTION

To solve this problem, the invention provides a separating method according to one or more embodiments. A method, in particular an automated method, for inserting slot cover slides in which such a separating process is carried out as a sub-step, is, for example, disclosed herein. A separating device for carrying out the separating method and the use of such a separating device in the manufacture of stators are also disclosed herein.

According to a first aspect thereof, the invention provides a separating method to be carried out in the course of manufacturing a stator for separating slot cover slides for covering stator slots provided with conductors for forming a coil winding, the method comprising the steps of:
a) providing a quantity of strip-shaped slot cover slides in such a way that the slot cover slides are aligned with each other in the longitudinal direction, but are otherwise present in a disordered state as a bulk material,
b) providing a counterpart (=separating tool) which has an upwardly facing surface with at least one upwardly open slot which is complementarily adapted to the shape of the slot cover slides and in which a slot cover slide can preferably be accommodated in an aligned manner,
c) arranging the quantity of slot cover slides parallel to the at least one slot;
d) relatively moving the quantity of slot cover slides and the counterpart in the direction transverse to the longitudinal extension of the slot and the slot cover slides aligned therewith, so that the quantity of slot cover slides is moved over the region of the surface provided with the slot,
e) inserting a slot cover slide into the slot in order to align the slot cover slide also with respect to its angular position about its longitudinal center axis in the slot.

It is preferred that steps a) and c) are carried out by means of the step:
a1) inserting a quantity of strip-shaped slot cover slides into an elongated receptacle aligned with the longitudinal direction of the slot in such a way that the slot cover slides are aligned therein in the longitudinal direction, but are otherwise present in a disordered state as bulk material and can be dispensed via an elongated dispensing opening at the lower end of the receptacle, and that step d) comprises:
d1) relatively moving the receptacle over the counterpart, so that the receptacle with the dispensing opening and the region of the surface provided with the slot are moved past one another relative to one another.

It is preferred that step e) is carried out using at least one scraper that is moved in the direction of movement after the dispensing opening over the surface and the slot in order to push a slot cover slide, which is dispensed at the dispensing opening and rests on the surface, into the slot.

It is preferred that steps a) and c) are carried out by means of the step:
a2) depositing the quantity of strip-shaped slot cover slides on the surface of the counterpart in such a way that the slot cover slides are aligned with their longitudinal direction with each other and with the at least one slot and that step d) comprises:
   d2) relatively moving the quantity of slot cover slides aligned according to step a2) and the surface in the direction transverse to the longitudinal direction of the slot cover slides and the slot, so that the slot cover slides are displaced over the region of the surface provided with the slot.

Preferably, step b) comprises:
b1) providing the counterpart in such a way that the surface is curved or cylinder jacket-shaped, preferably with a curvature adapted to the radius of the stator to be provided with slot cover slides.

Preferably, step b) comprises:
b2) providing the counterpart in such a way that the surface has a plurality of slots arranged next to one another, in particular in such a way that the spacing of the slots corresponds to the spacing of the stator slots of the stator to be provided with slot cover slides.

Preferably, step b) comprises:
b3) providing the counterpart in such a way that the surface is flat.

Preferably, step d) comprises:
d3) relatively moving the quantity of slot cover slides back and forth over the surface and the slot.

Preferably, step d) comprises:
d4) moving the quantity of slot cover slides, preferably with the counterpart stationary, in particular by moving the receptacle or by moving a blade or slider pushing the quantity of slot cover slides.

Preferably, step d) comprises:
d5) moving the counterpart, preferably when the quantity of slot cover slides is stationary.

Preferably, step d) comprises:
d6) pivoting the quantity of slot cover slides, in particular in the receptacle, relative to the counterpart having a curved surface.

Preferably, step d) comprises:
d7) linearly moving the quantity of slot cover slides, in particular in the receptacle, relative to the counterpart having a flat surface.

Preferably, step e) comprises:
e1) using at least one scraper to be moved over the surface of the counterpart to push the slot cover slides into the slot.

Preferably, step e) comprises:
e2) providing one scraper on each longitudinal side of a slider or on each longitudinal side of the dispensing opening of the receptacle, preferably in the region of each lower longitudinal edge of the receptacle.

Preferably, step e) comprises:
e3) using a brush arrangement or brush strip for brushing-in the slot cover slides, in particular using the brush arrangement as a scraper.

According to a further aspect, the invention provides an insertion method to be carried out in the course of a manufacturing process for a stator for inserting slot cover slides into stator slots for the purpose of covering conductors located therein, comprising:
1) providing an annular stator component having stator slots in which conductors for forming a coil winding are received,
2) providing separated slot cover slides by carrying out the separation process according to any one of the preceding embodiments,
3) transferring the respective slot cover slide from the slot in the surface into the stator slot in order to cover the conductors.

Preferably, the insertion method comprises step b):
b1a) providing the counterpart so that the upwardly facing surface is provided with a concave curvature adapted to the stator component, and in the concavely curved surface the at least one upwardly open slot extending in the axial direction and complementarily adapted to the shape of the slot cover slide is provided, wherein the curvature and the arrangement of the at least one slot are selected such that the radial position of the at least one slot corresponds to the radial position of the inserted slot cover slide in a stator slot.

Preferably, step 3) comprises:
f) aligning the at least one slot in the separating tool with at least one stator slot and
g) displacing the respective slot cover slide in the longitudinal direction from the slot of the separating tool into the stator slot aligned therewith.

According to a further aspect, the invention provides a separating device for carrying out the separating process according to any one of the preceding embodiments, comprising:
a supply device for supplying a quantity of strip-shaped slot cover slides in such a way that the slot cover slides are aligned in the longitudinal direction and are otherwise present in a disordered state as a bulk material;
a counterpart with an upwardly facing surface in which an upwardly open slot is provided which is adapted to the outer contour of the slot cover slides and in which a slot cover slide can be accommodated in an aligned manner, and
a movement device for relatively moving the quantity of slot cover slides aligned with the longitudinal direction of the slot and the counterpart in order to move the quantity of slot cover slides over the slot.

It is preferred that the supply device comprises an elongate receptacle for receiving a quantity of strip-shaped slot cover slides, wherein the receptacle has an elongate dispensing opening so that the slot cover slides can be received in the receptacle aligned in the longitudinal direction, but are otherwise present in a disordered state as a bulk material, wherein the at least one slot is aligned with the longitudinal direction of the receptacle and wherein the movement device is designed to move the receptacle relative to the counterpart in order to move the dispensing opening over the surface having the slot.

It is preferred that at least one scraper made of flexible material for inserting the slot cover slide to be separated into the slot is arranged in the region of at least one longitudinal edge of the dispensing opening, preferably on both sides.

It is preferred that the receptacle has a rectangular, parallelogram-shaped or trapezoidal cross-section.

It is preferred that brushes for inserting the slot cover slide to be separated into the slot are arranged on both lower corner edges of the receptacle extending in the longitudinal direction.

In the counterpart, it is preferred that the surface is curved, preferably in an arc shape, at least in areas.

In the counterpart, it is preferred that the surface is at least partially flat.

In the counterpart, it is preferred that the surface has several of the slots, which are arranged next to each other.

It is preferred that the movement device is designed to move the quantity of slot cover slides or the receptacle.

It is preferred that the movement device is designed to move the counterpart.

It is preferred that the movement device is designed to pivot the quantity of slot cover slides or the receptacle relative to the counterpart.

It is preferred that the movement device is designed for linear movement of the quantity of slot cover slides or the receptacle relative to the counterpart.

It is preferred that the movement device is pivotable about a pivot axis. It is preferred that the movement device has a blade or a slider for pushing the aligned quantity of slot cover slides over the surface.

According to a further aspect, the invention provides the use of a separating device according to any one of the preceding embodiments for producing a stator, wherein the slot cover slide arranged aligned in the slot of the counterpart is pushed into a stator slot for covering conductors, wherein in particular the curvature of the surface of the counterpart is adapted to the curvature of the region of the stator provided with the mouths of the stator slots to be covered.

Preferred embodiments of the invention relate to the handling of slot cover slides, in particular the separation and provision for their pushing or insertion into stator slots.

Preferred embodiments of the invention allow the cover slides to initially be separated and provided in the correct position so that they can be inserted into the stator with as little handling effort as possible.

### BRIEF DESCRIPTION OF THE DRAWINGS

One exemplary embodiment will be explained in more detail below with reference to the accompanying drawings. In the drawings:

FIG. 1 isa schematic cross-sectional view of a first embodiment of a separating device;

FIG. 2a is a sectional view of a region of a counterpart that can be used for separating and aligning slot cover slides and is provided with a slot, in a first step for inserting a slot cover slide into a slot;

FIG. 2b is a sectional view of the region shown in FIG. 2a in a second step for inserting the slot cover slide into the slot;

FIG. 2c is a sectional view of the region shown in FIG. 2a in a third step for inserting the slot cover slide into the slot;

FIG. 2d is a sectional view of the region shown in FIG. 2a in a fourth step for inserting the slot cover slide into the slot;

FIG. 3 is a schematic cross-sectional view of a second embodiment of a separating device;

FIG. 4 is a schematic cross-sectional view of a third embodiment of a separating device;

FIG. 5 is a schematic cross-sectional view of a fourth embodiment of a separating device;

FIG. 6 is a schematic cross-sectional view of a fifth embodiment of a separating device; and

FIG. 7 is a schematic cross-sectional view of an arrangement of a separating device in an embodiment according to one of FIGS. 1, 3 to 6 and of a laminated core for forming a stator in the course of manufacturing the stator.

### DETAILED DESCRIPTION OF THE PREFERRED EMBODIMENTS

In the following, various embodiments of a separation method and of advantageous separating devices 10 are explained with reference to the Figures. The separation method can be carried out particularly advantageously using one of the illustrated embodiments of the separating device 10, but can also be carried out in other ways.

The separation method is a method for separating and preferably providing slot cover slides 12 in the correct position in the course of manufacturing a stator 14. The slot cover slides 12 are designed to cover stator slots 16 which are provided with conductors for forming a coil winding.

The separation method comprises the steps of:
a) providing a quantity 18 of strip-shaped slot cover slides 12 in such a way that the slot cover slides 12 are aligned with each other in the longitudinal direction, but are otherwise present in a disordered state as a bulk material,
b) providing a separating tool (referred to here as counterpart 20) which has an upwardly facing surface 22 with at least one upwardly open slot 24 complementarily adapted to the shape of the slot cover slides 12,
c) arranging the quantity 18 of slot cover slides 12 parallel to the at least one slot 24;
d) relatively moving the quantity 18 of slot cover slides 12 and the counterpart 20 in a direction transverse to the longitudinal extension of the slot 24 and the slot cover slides 12 aligned therewith, so that the quantity 18 of slot cover slides 12 is moved over the region of the surface 22 provided with the slot 24,
e) inserting a slot cover slide 12 into the slot 24 to align the slot cover slide 12 also with respect to its angular position about its longitudinal central axis in the slot 24.

The designation of the steps with a), b), c), . . . is merely for ease of reference and does not indicate a specific sequence of the steps. Preferably, steps a) and c) are carried out jointly by providing the quantity 18 of slot cover slides already in the position parallel to the slot on the surface 22. This can be done by providing a receptacle in which the quantity 18 is contained and which is movable relative to the counterpart 20, or the slot cover slides 12 are placed on the surface 22, in particular in the longitudinal direction relative to one another, and oriented in the direction of the slot and then moved over the surface relative to the counterpart 20. The relative movement between the quantity 18 of slot cover slides 12 and the counterpart 20 can be achieved by moving the quantity 18 of slot cover slides 12 while the counterpart 20 is stationary or, alternatively, by moving the counterpart 20 while the quantity 18 is stationary or by moving the counterpart 20 and the quantity 18 of slot cover slides 12 in opposite directions.

During this movement, a slot cover slide 12 is inserted into the slot 24 or into one of several slots 24 in the surface 22 of the counterpart 20. The slot cover slide 12, which was previously aligned only in the longitudinal direction and was otherwise arranged in a disordered manner in the quantity 18, is then also aligned in the slot 24 with regard to the position of its cross-section by the outer contour of the slot cover slide 12 fitting the complementary shape of the slot. Thus, the slot cover slide 12 is also aligned in the slot 24 with respect to its angular position around its longitudinal center axis (i.e. rotational position relative to its longitudinal axis).

The drawings each show cross-sections through different embodiments of the separating device 10, wherein the cross-sections extend transversely to the longitudinal direction or longitudinal central axis of the slots 24 and also of the slot cover slides 12 aligned parallel thereto. Corresponding parts of the separating device 10 are each provided with corresponding reference numerals, and they are each described only once. The different features of the different embodiments of the separating device 10 can be combined with each other as desired.

In the various embodiments shown in the Figures, the separating device 10 has the separating tool, referred to here as counterpart 20, with the upwardly facing surface 22 and the at least one slot 24 formed in the surface 22, as well as an optional movement device 28. The movement device 28 is configured to relatively move the quantity 18 of slot cover slides 12 and the counterpart 20 aligned with the longitudinal direction of the slot 24, so as to move the quantity 18 of slot cover slides 12 over the slot 24. In some embodiments, the optional receptacle 26 is provided.

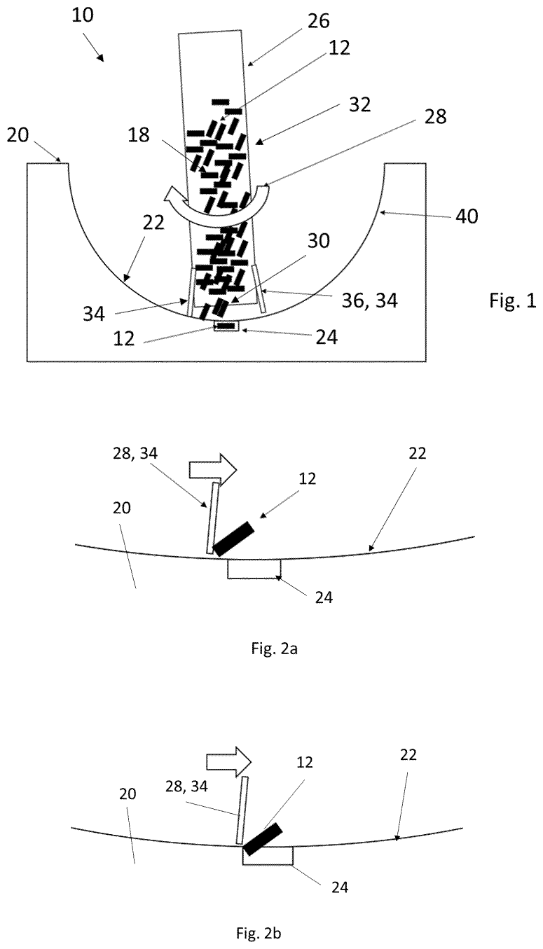

FIG. 1 shows a first embodiment of the separating device 10. The separating device 10 has the receptacle 26 for the slot cover slides 12, the counterpart 20, and the movement device 28. The slot cover slides 12 are aligned longitudinally, but do not have an exact orientation to the rotational position (angular position) about the longitudinal axis. The receptacle 26 is pivotable here by means of the movement device 28 and can pivot from one side to the other in the counterpart 20. In this case, the surface 22 is curved in an arc shape. The slot 24, which is adapted to the geometry of the respective slot cover slide 12, is located in the counterpart 20, which is hollow as a result. The movement device 28 has a pivot drive, not shown in detail, for pivoting the receptacle 26 back and forth.

The receptacle 26 is elongated to accommodate a number of strip-shaped slot cover slides 12. For example, the receptacle 26 is box-shaped or funnel-shaped. The receptacle 26 has an elongated dispensing opening 30. The slot cover slides 12 are thus aligned in the longitudinal direction in the receptacle 26, but are otherwise present in a disordered state as a bulk material. In particular, they are still unoriented with regard to their angular position around the longitudinal axis. The slot cover slides 12 can thus simply be poured into the receptacle 26 from above. The receptacle 26 is an example of a supply device 32 for supplying a quantity 18 of slot cover slides 12, which are aligned with each another in their longitudinal direction, but can otherwise be present as a bulk material. By arranging the receptacle 26 parallel to the slot 24, the slot cover slides 12 can be aligned overall parallel to the slot 24 (example for carrying out step c)).

At the dispensing opening 30, the receptacle 26 has at least one scraper 34. In the embodiments shown, a scraper 34 is provided on each longitudinal side of the dispensing opening 30. The scraper 34 can be designed differently, preferably the scraper 34 is designed in the form of a strip with a flexible region for sweeping over the surface 22. Particularly preferably, the scraper 34 has at least one brush 36 in each case.

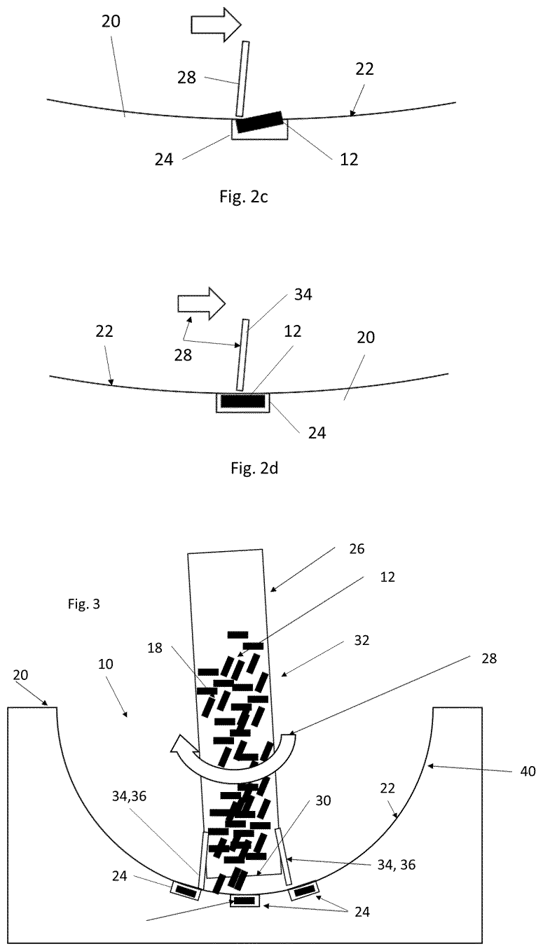

During the pivoting process over the slot 24, a slot cover slide 12 is separated in this slot 24. The individual steps for inserting the slot cover slide 12 into the slot 24 are shown in FIGS. 2a to 2d. The slot cover slide 12 is pushed over the surface 22 as far as the slot 24 by means of the scraper 34/brush 36 and then inserted into the slot 24, where it fits with its outer contour in the complementary shape of the slot and is thus aligned in its rotational position or angular position with respect to its longitudinal axis.

In some embodiments, for example as shown in FIGS. 1, 3, 5 to 7, the surface 22 of the counterpart 20 has a radius/diameter 40 which-as shown in FIG. 7—is adapted to the stator 14, or more precisely its laminated stack 38. This means that the slot cover slide 12 can be inserted into the stator 14 in the correct position. This means that no further reorientation is necessary.

As shown in the embodiment of FIG. 3, several of the slots 24 can also be formed on the surface 22, preferably in such a way that their position and spacing is adapted to the position and spacing of the stator slots 16. Thus, the separation and alignment in the several slots 24 can take place simultaneously and the insertion of the slot cover slides 12 from the slots 24 into the respective stator slots 16 can also take place simultaneously. Accordingly, the counterpart 20 can be expanded by further slots 24; and thus several slot cover slides 12 can be separated with one pivoting movement and then inserted simultaneously.

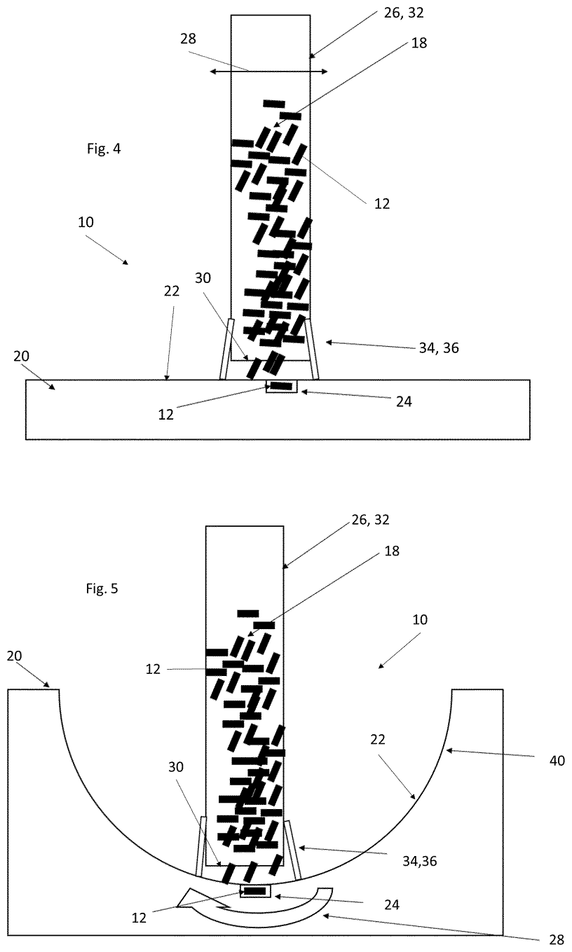

As shown in the embodiment of FIG. 4, the surface 22 of the counterpart 20 can also be designed to deviate from the curvature of the laminated stack 38, in this case linearly, for example. The movement device 28 then moves the quantity 18 of slot cover slides 12 linearly relative to the counterpart 20, for example by moving the receptacle 26 linearly back and forth over the counterpart 20.

As shown in FIG. 4, the counterpart 20 can also be designed flat, without a radius, if there is only one slot 24. With a linear design, it would also be possible to provide for a reorientation of the slot cover slide for adaptation to the position in the stator slot by means of an additional template during insertion (not shown). Thus, the multiple slots 24 can also be provided in the flat design, in which case the slot cover slides 12 are simultaneously transferred into the stator slots 16, possibly with reorientation via the additional templates.

As already mentioned above, the movement device 28 can be designed to move the quantity 18 of slot cover slides 12 over the surface 22 when the counterpart 20 is stationary, as shown in the embodiments of FIGS. 1 to 4 and 6 and 7. However, as shown in the embodiment according to FIG. 5, the movement device 28 can also be designed to move the counterpart 20 when the quantity 18 of slot cover slides 12 is stationary (or moving in the opposite direction), in particular to swing back and forth.

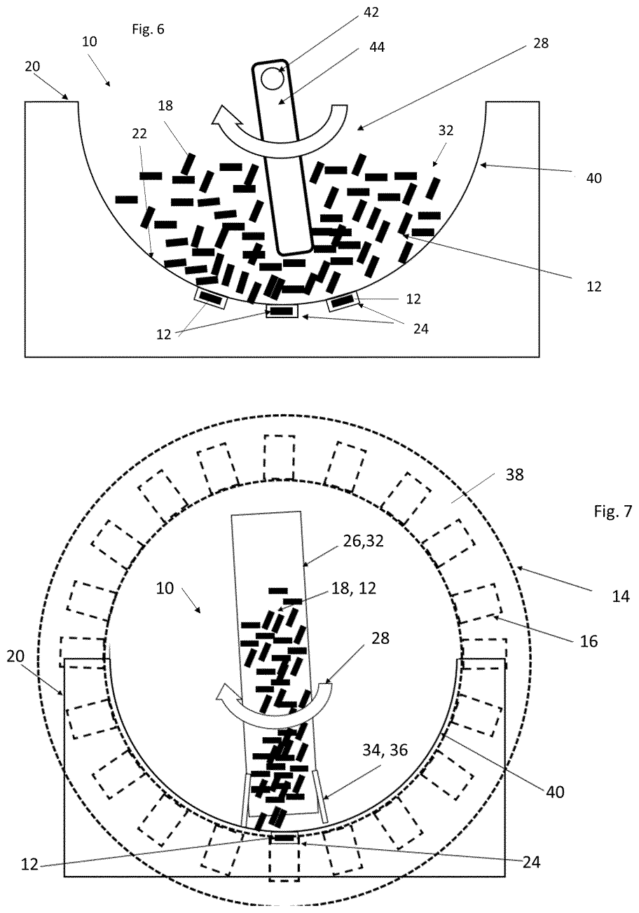

FIG. 6 shows a further embodiment of the separating device 10 that does not require the receptacle 26. The supply device 32 is essentially formed here by the separating tool (referred to here as counterpart 20), on which the quantity 18 of slot cover slides 12 can be deposited correspondingly in the longitudinal direction to the slot 24. Here, the movement device 28 has a pusher or the like, such as, for example, a blade 44 that can be rotated or pivoted back and forth about an axis of rotation 42.

The slot cover slides 12 are here filled directly into the counterpart 20 and are guided past the slots 24 (a design with only one slot 24 is also possible) by the blade 44 or the like. The quantity 18 of slot cover slides 12 set in motion pushes individual slot cover slides 12 past the slots 24, which individual slot cover slides 12 are deposited in the open slots 24 and separated. Thus, it is not necessary for the blade 44 or the like to extend to the surface 22 of the counterpart 20. In some embodiments not shown, it is also advantageous for certain cases for the blade 44 to extend to the bottom-i.e. in this case the surface 22.

In further embodiments not shown, it is further provided that the separation process is also optimized in this case by using a scraper 34, e.g. with additional brushes 36 on the blade 44.

FIG. 7 shows the process to be carried out in the course of the manufacturing method for the stator 14 for inserting slot cover slides 12 into stator slots 16 for the purpose of covering conductors located therein, comprising:
providing the annular stator component—e.g. the laminated stack 38—having stator slots 16 in which conductors (not shown) are received to form a coil winding,
providing the separated slot cover slides by carrying out the separation process as explained above, in this case by placing the counterpart 20 with the individual slot cover slide 12 received in the correct position in the at least one slot 24;
transferring the respective slot cover slide 12 from the slot 24 in the surface 22 into the stator slot 16 in order to cover the conductors.

The following steps are preferably carried out for this purpose:
f) aligning the at least one slot 24 in the separating tool with at least one stator slot 16—in particular by turning the stator component about its axis until the slots 24, 16 are aligned with each other—and
g) displacing the respective slot cover slide 12 in the longitudinal direction from the slot 24 of the separating tool into the stator slot 16 aligned therewith.

In order to considerably simplify the handling of slot cover slides (12) and in particular to enable its automation, a separating method to be carried out in the course of the manufacture of a stator (14) for separating slot cover slides (12) for covering stator slots (16) provided with conductors for forming a coil winding has been described, comprising the steps of
a) providing a quantity (18) of strip-shaped slot cover slides (12) in such a way that the slot cover slides (12) are aligned with each other in the longitudinal direction, but are otherwise present in a disordered state as a bulk material,
b) providing a counterpart (20) which has an upwardly facing surface (22) with at least one upwardly open slot (24) complementarily adapted to the shape of the slot cover slides (12),
c) arranging the quantity (18) of slot cover slides (12) parallel to the at least one slot (24);
d) relatively moving the quantity (18) of slot cover slides (12) and counterpart (20) in a direction transverse to the longitudinal extension of the slot (24) and the slot cover slides (12) aligned therewith, so that the quantity (18) of slot cover slides (12) is moved over the region of the surface (22) provided with the slot (24),
e) inserting a slot cover slide (12) into the slot (24) to align the slot cover slide (12) also with respect to its rotational position about its longitudinal axis in the slot (24).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 separating device
12 slot cover slide
14 stator
16 stator slot
18 quantity of slot cover slide
20 counterpart (separating tool)
22 surface facing upwards
24 slot (counterpart)
26 receptacle
28 movement device
30 dispensing opening
32 supply device
34 scraper
36 brushes
38 laminated stack
40 diameter adapted to stator
42 rotation axis
44 blade

1.-15. (canceled)

16. A method for separating slot cover slides for covering stator slots provided with conductors for forming a coil winding while manufacturing a stator, the method comprising the steps of:
a) providing a plurality of strip-shaped slot cover slides in such a way that the strip-shaped slot cover slides are aligned with each other in a longitudinal direction, but are otherwise present in a disordered state as a bulk material,
b) providing a counterpart which has an upwardly facing surface with at least one upwardly open slot complementarily adapted to a shape of the strip-shaped slot cover slides,
c) arranging the plurality of strip-shaped slot cover slides parallel to the at least one upwardly open slot;
d) relatively moving the plurality of strip-shaped slot cover slides and the counterpart in a direction transverse to a longitudinal extension of the at least one upwardly open slot and the strip-shaped slot cover slides aligned therewith, so that the plurality of strip-shaped slot cover slides is moved over a region of the upwardly facing surface provided with the at least one upwardly open slot
e) inserting a strip-shaped slot cover slide from the plurality into the at least one upwardly open slot in order to align the strip-shaped slot cover slide also with respect to a rotational position about a longitudinal axis in the at least one upwardly open slot.

17. The method according to claim 16, wherein steps a) and c) are carried out by:
a1) inserting the plurality of strip-shaped slot cover slides into an elongate receptacle aligned with the longitudinal direction of the at least one upwardly open slot in such a way that the strip-shaped slot cover slides are present therein aligned in the longitudinal direction, but otherwise present in the disordered state as the bulk material and are configured to be dispensed via an elongate dispensing opening at a lower end of the elongate receptacle, and wherein step d) comprises:
d1) relatively moving the elongate receptacle over the counterpart so that the elongate receptacle with the elongate dispensing opening and a region of the upwardly facing surface provided with the at least one upwardly open slot are moved past one another relative to one another.

18. The method according to claim 17, wherein step e) is carried out using at least one scraper configured to move in a direction of movement after the elongate dispensing opening over the upwardly facing surface and the at least one upwardly open slot in order to push a the strip-shaped slot cover slide, which is dispensed at the elongate dispensing opening and rests on the upwardly facing surface, into the at least one upwardly open slot.

19. The method according to claim 16, wherein steps a) and c) are carried out by:
a2) depositing the plurality of strip-shaped slot cover slides on the upwardly facing surface of the counterpart in such a way that the strip-shaped slot cover slides are aligned with their longitudinal direction with each other and with the longitudinal extension of the at least one upwardly open slot, and in that step d) comprises:
d2) relatively moving the plurality of strip-shaped slot cover slides aligned according to step a2) and the upwardly facing surface in the direction transverse to the longitudinal direction of the strip-shaped slot cover slides and the at least one upwardly open slot, so that the strip-shaped slot cover slides are displaced over the region of the upwardly facing surface provided with the at least one upwardly open slot.

20. The method according to claim 16, wherein step b) comprises at least one or more of the following steps:
b1) providing the counterpart in such a way that the upwardly facing surface is curved or cylinder jacket-shaped;
b2) providing the counterpart in such a way that the upwardly facing surface has several slots arranged next to one another in such a way that a spacing of the several slots corresponds to a spacing of stator slots of a stator provided with the strip-shaped slot cover slides;
b3) providing the counterpart in such a way that the upwardly facing surface is flat; and,
b4) providing the counterpart in such a way that the upwardly facing surface is curved or cylinder jacket-shaped preferably with a curvature adapted to a radius of a stator provided with the strip-shaped slot cover slides.

21. The method according to claim 16, wherein step d) comprises at least one or more of the following steps:
d3) relatively moving the plurality of strip-shaped slot cover slides back and forth over the upwardly facing surface and the at least one upwardly open slot;
d4) moving the plurality of strip-shaped slot cover slides by moving a receptacle or by moving a blade or pusher pushing the plurality of strip-shaped slot cover slides;
d5) moving the counterpart with the plurality of strip-shaped slot cover slides being stationary;
d6) pivoting the plurality of strip-shaped slot cover slides, in a receptacle, relative to the counterpart having a curved surface;
d7) linearly moving the plurality of strip-shaped slot cover slides in a receptacle relative to the counterpart having a flat surface; and,
d8) moving the plurality of strip-shaped slot cover slides with the counterpart stationary by moving a receptacle or by moving a blade or pusher pushing the plurality of strip-shaped slot cover slides.

22. The method according to claim 16, wherein step e) comprises:
e1) moving at least one scraper over the upwardly facing surface of the counterpart in order to push the strip-shaped slot cover slides into the at least one upwardly open slot;
e2) providing a scraper on each longitudinal side of a slider or on each longitudinal side of a dispensing opening of a receptacle; and,
e3) using a brush arrangement or brush strip for brushing-in the strip-shaped slot cover slides.

23. A method for inserting slot cover slides into stator slots for covering conductors located therein during while manufacturing a stator, the method comprising:
providing an annular stator component having stator slots in which conductors for forming a coil winding are received,
providing separated slot cover slides by carrying out the method according to claim 16, and,
transferring a respective slot cover slide from the at least one upwardly open slot in the upwardly facing surface into a stator slot of the annular stator component to cover the conductors.

24. The method according to claim 23, wherein step b) comprises:
b1a) providing the counterpart so that the upwardly facing surface is provided with a concave curvature adapted to the annular stator component, wherein in the upwardly facing surface the at least one upwardly open slot extending in an axial direction and complementarily adapted to the shape of the slot cover slide is provided, wherein the curvature of the upwardly facing surface and the arrangement of the at least one upwardly open slot are selected such that a radial position of the at least one upwardly open slot corresponds to the radial position of the inserted slot cover slide in the stator slot; and
wherein the transferring step comprises:
f) aligning the at least one upwardly open slot in the counterpart with at least one stator slot; and
g) displacing the slot cover slide in the longitudinal direction out of the at least one upwardly open slot of the counterpart into the stator slot aligned therewith.

25. A device for separating slot cover slides for covering stator slots provided with conductors for forming a coil winding while manufacturing a stator, the device comprising:
a supply device for supplying a plurality of strip-shaped slot cover slides such that the slot strip-shaped slot cover slides are aligned in a longitudinal direction, but are otherwise present in a disordered state as a bulk material;
a counterpart with an upwardly facing surface in which at least one upwardly open slot is provided which is adapted to an outer contour of the strip-shaped slot cover slides and in which a respective slot cover slide is configured to be accommodated in an aligned manner, and
a movement device for relatively moving the plurality of strip-shaped slot cover slides aligned with the longitudinal direction of the at least one upwardly open slot and the counterpart in order to move the plurality of strip-shaped slot cover slides over the at least one upwardly open slot.

26. The device according to claim 25, wherein the supply device comprises an elongate receptacle for receiving the plurality of strip-shaped slot cover slides, the elongate receptacle having an elongate dispensing opening, so that the strip-shaped slot cover slides are aligned in the elongate receptacle in the longitudinal direction, but are otherwise present in a disordered state as a bulk material, wherein the at least one upwardly open slot is aligned with the longitudinal direction of the elongate receptacle and wherein the movement device is designed to move the elongate receptacle relative to the counterpart in order to move the elongate dispensing opening over the upwardly facing surface having the at least one upwardly open slot.

27. The device according to claim 26, wherein the elongate receptacle comprises at least one or more of the following features:
in a region of at least one longitudinal edge of the dispensing opening, at least one scraper made of flexible material for inserting a strip-shaped slot cover slide to be separated into the at least one upwardly open slot;
a rectangular, parallelogram-shaped, or trapezoidal cross-section; and,
brushes for inserting a strip-shaped slot cover slide to be separated into the at least one upwardly open slot are arranged at two lower corner edges extending in the longitudinal direction.

28. The device according to claim 25, wherein the counterpart has at least one or more of the following features:
the upwardly facing surface is curved;
the upwardly facing surface is at least partially flat; and
the upwardly facing surface has several of slots which are arranged next to one another.

29. The device according to claim 25, wherein the movement device is configured to move the plurality of strip-shaped slot cover slides or a receptacle, or
wherein the movement device is configured to move the counterpart, or
wherein the movement device is configured to pivot the plurality of strip-shaped slot cover slides or a receptacle relative to the counterpart, or
wherein the movement device is configured to move the plurality of strip-shaped slot cover slides or a receptacle linearly relative to the counterpart; or
wherein the movement device comprises a blade or a pusher for pushing an aligned quantity of strip-shaped slot cover slides over the upwardly facing surface.
